(19) United States
(12) Patent Application Publication
(10) Pub. No.: US 2023/0102629 A1
(43) Pub. Date: Mar. 30, 2023

(54) PROCESSING SYSTEM, PROCESSING DEVICE, PROCESSING METHOD, AND COMPUTER PROGRAM PRODUCT

(71) Applicants: DENSO CORPORATION, Kariya-city (JP); TOKYO INSTITUTE OF TECHNOLOGY, Tokyo (JP)

(72) Inventors: TADASHI KADOWAKI, Kariya-city (JP); HIDETOSHI NISHIMORI, Tokyo (JP)

(21) Appl. No.: 17/664,821

(22) Filed: May 24, 2022

(30) Foreign Application Priority Data
Sep. 27, 2021 (JP) 2021-157193

(51) Int. Cl. G06N 10/60

(52) U.S. Cl. CPC G06N 10/60

(57) ABSTRACT

A processing system includes a processor configured to perform an annealing process to individually control, depending on time, each contribution of a cost function, a transverse field function, and an orthogonal field function, and perform an optimization process to sequentially determine an optimal value of the contribution of the orthogonal field function based on a final state of the annealing process. The processor is configured to extract the qubit that optimizes an evaluation indicator for the final state of the annealing process in which an intensity parameter for maximizing the orthogonal field function is varied, based on a gradient caused by the variation. The processor is configured to determine the intensity parameter that gives the optimal value for the extracted qubit based on the gradient, and output an optimal solution of the combinatorial optimization problem by mapping a set of the intensity parameters determined for each of the qubits.

### CROSS REFERENCE TO RELATED APPLICATION

This application is based on and incorporates herein by reference Japanese Patent Application No. 2021-157193 filed on Sep. 27, 2021.

### TECHNICAL FIELD

The present disclosure relates to a processing technique for solving a combinatorial optimization problem with binary variables.

### BACKGROUND

In the quantum annealing just varying the transverse magnetic field over time, there was a limit to output the optimal solution with high accuracy in a short annealing time.

### SUMMARY

According to a first aspect of the present disclosure, a processing system is configured to solve a combinatorial optimization problem with binary variables by controlling a quantum annealer with qubits. The processing system includes a processor configured to: perform an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and perform an optimization process to sequentially determine an optimal value of the contribution of the orthogonal field function for each of the qubits corresponding to one of the binary variables of the combinatorial optimization problem based on a final state of the annealing process. The processor is configured to, in the optimization process: extract, from the qubits that have not been optimized, the qubit that optimizes an evaluation indicator for the final state of the annealing process in which an intensity parameter that gives a maximum value of the orthogonal field function is varied, based on a gradient caused by the variation; determine the intensity parameter that gives the optimal value for the extracted qubit based on the gradient; and output an optimal solution of the combinatorial optimization problem by mapping a set of the intensity parameters determined for each of the qubits.

According to a second aspect of the present disclosure, a processing device is configured to solve a combinatorial optimization problem with binary variables by controlling a quantum annealer with qubits. The processing device includes a processor configured to: perform an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and perform an optimization process to sequentially determine an optimal value of the contribution of the orthogonal field function for each of the qubits corresponding to one of the binary variables of the combinatorial optimization problem based on a final state of the annealing process. The processor is configured to, in the optimization process: extract, from the qubits that have not been optimized, the qubit that optimizes an evaluation indicator for the final state of the annealing process in which an intensity parameter that gives a maximum value of the orthogonal field function is varied, based on a gradient caused by the variation; determine the intensity parameter that gives the optimal value for the extracted qubit based on the gradient; and output an optimal solution of the combinatorial optimization problem by mapping a set of the intensity parameters determined for each of the qubits.

According to a third aspect of the present disclosure, a processing device is configured to solve a combinatorial optimization problem with binary variables by controlling a quantum annealer with qubits. The processing device includes a processor. An annealing process is defined as a process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function. An optimization process is defined as a process to sequentially determine an optimal value of the contribution of the orthogonal field function for each of the qubits corresponding to one of the binary variables of the combinatorial optimization problem based on a final state of the annealing process. The processor is configured to, as the optimization process: extract, from the qubits that have not been optimized, the qubit that optimizes an evaluation indicator for the final state of the annealing process in which an intensity parameter that gives a maximum value of the orthogonal field function is varied, based on a gradient caused by the variation; determine the intensity parameter that gives the optimal value for the extracted qubit based on the gradient; and output an optimal solution of the combinatorial optimization problem by mapping a set of the intensity parameters determined for each of the qubits.

According to a fourth aspect of the present disclosure, a processing method to solve a combinatorial optimization problem with binary variables by controlling a quantum annealer with qubits includes: performing an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and performing an optimization process to sequentially determine an optimal value of the contribution of the orthogonal field function for each of the qubits corresponding to one of the binary variables of the combinatorial optimization problem based on a final state of the annealing process. The optimization process includes: extracting, from the qubits that have not been optimized, the qubit that optimizes an evaluation indicator for the final state of the annealing process in which an intensity parameter that gives a maximum value of the orthogonal field function is varied, based on a gradient caused by the variation; determining the intensity parameter that gives the optimal value for the extracted qubit based on the gradient; and outputting an optimal solution of the combinatorial optimization problem by mapping a set of the intensity parameters determined for each of the qubits.

A fifth aspect of the present disclosure is a processing method to solve a combinatorial optimization problem with binary variables by controlling a quantum annealer with qubits. An annealing process is defined as a process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function. An optimization process is defined as a process to sequentially determine an optimal value of the contribution of the orthogonal field function for each of the qubits corresponding to one of the binary variables of the combinatorial optimization problem based on a final state of the annealing process. The processing method includes, as the optimization process: extracting, from the qubits that have not been optimized, the qubit that optimizes an evaluation indicator for the final state of the annealing process in which an intensity parameter that gives a maximum value of the orthogonal field function is varied, based on a gradient caused by the variation; determining the intensity parameter that gives the optimal value for the extracted qubit based on the gradient; and outputting an optimal solution of the combinatorial optimization problem by mapping a set of the intensity parameters determined for each of the qubits.

A sixth aspect of the present disclosure is a computer program product stored on at least one non-transitory computer readable medium to solve a combinatorial optimization problem with binary variables by controlling a quantum annealer with qubits. The computer program product includes instructions configured to, when executed by at least one processor, cause the at least one processor to: perform an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and perform an optimization process to sequentially determine an optimal value of the contribution of the orthogonal field function for each of the qubits corresponding to one of the binary variables of the combinatorial optimization problem based on a final state of the annealing process. The instructions are configured to, when executed by the at least one processor, cause the at least one processor to, in the optimization process: extract, from the qubits that have not been optimized, the qubit that optimizes an evaluation indicator for the final state of the annealing process in which an intensity parameter that gives a maximum value of the orthogonal field function is varied, based on a gradient caused by the variation; determine the intensity parameter that gives the optimal value for the extracted qubit based on the gradient; and output an optimal solution of the combinatorial optimization problem by mapping a set of the intensity parameters determined for each of the qubits.

A seventh aspect of the present disclosure is a computer program product stored on at least one non-transitory computer readable medium to solve a combinatorial optimization problem with binary variables by controlling a quantum annealer with qubits. An annealing process is defined as a process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function. An optimization process is defined as a process to sequentially determine an optimal value of the contribution of the orthogonal field function for each of the qubits corresponding to one of the binary variables of the combinatorial optimization problem based on a final state of the annealing process. The computer program product includes instructions configured to, when executed by at least one processor, cause the at least one processor to, as the optimization process: extract, from the qubits that have not been optimized, the qubit that optimizes an evaluation indicator for the final state of the annealing process in which an intensity parameter that gives a maximum value of the orthogonal field function is varied, based on a gradient caused by the variation; determine the intensity parameter that gives the optimal value for the extracted qubit based on the gradient; and output an optimal solution of the combinatorial optimization problem by mapping a set of the intensity parameters determined for each of the qubits.

### BRIEF DESCRIPTION OF THE DRAWINGS

FIG. 1 is a block diagram illustrating an overall configuration of a processing system according to an embodiment.

FIG. 2 is a block diagram illustrating a functional configuration of the processing system according to the embodiment.

FIG. 3 is a time transition diagram for explaining an annealing process according to the embodiment.

FIG. 4 is a graph for explaining the annealing process according to the embodiment.

FIG. 5 is a table for explaining an optimization process according to the embodiment.

FIG. 6 is a graph for explaining the optimization process according to the embodiment.

FIG. 7 is a table for explaining the optimization process according to the embodiment.

FIG. 8 is a table for explaining the optimization process according to the embodiment.

FIG. 9 is a table for explaining the optimization process according to the embodiment.

FIG. 10 is a sequence diagram illustrating a processing method according to the embodiment.

### DETAILED DESCRIPTION

Hereinafter, an embodiment of the present disclosure will be described with reference to the drawings.

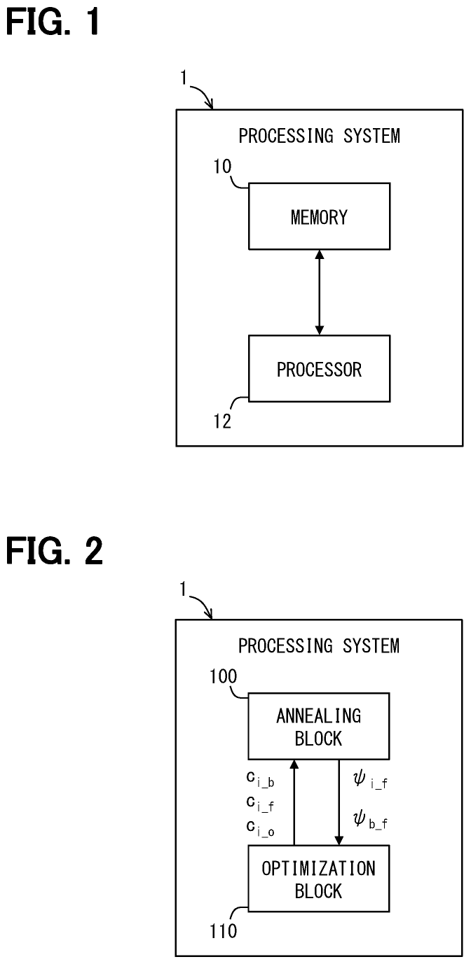

A processing system 1 of an embodiment shown in FIG. 1 is a quantum computing system configured to solve a combinatorial optimization problem with binary variables by controlling a quantum annealer with qubits. The processing system 1 includes, as at least one dedicated computer, a quantum computer configured to compute using qubits. The processing system 1 may include, as the dedicated computer, a classical computer configured to compute using classical bits in combination with the quantum computer. In the present embodiment, the quantum computer of the processing system 1 is a quantum annealing machine configured to perform a quantum annealing method, such as NISQ (noisy intermediate scale quantum) device.

The dedicated computer of the processing system 1 has at least one memory 10 and at least one processor 12. The memory 10 is at least one type of non-transitory tangible storage medium, such as a semiconductor memory, a magnetic medium, and an optical medium, for non-transitory storage of computer readable programs and data. The processor 12 has a quantum processing unit as a core configured to perform the quantum annealing method. When the dedicated computer of the processing system 1 is a combination of the quantum computer and the classical computer, the processor 12 may include at least one type of, for example, a CPU (Central Processing Unit), a GPU (Graphics Processing Unit), an RISC (Reduced Instruction Set Computer) CPU, and so on.

The processor 12 of the processing system 1 is configured to execute instructions included in at least one processing program stored in the memory 10 for solving the combinatorial optimization problem with binary variables by controlling the quantum annealer with qubits. Accordingly, the processor 12 builds functional blocks for solving the combinatorial optimization problem by controlling the quantum annealer. The functional blocks built in the processing system 1 includes an annealing block 100 and an optimization block 110 as shown in FIG. 2.

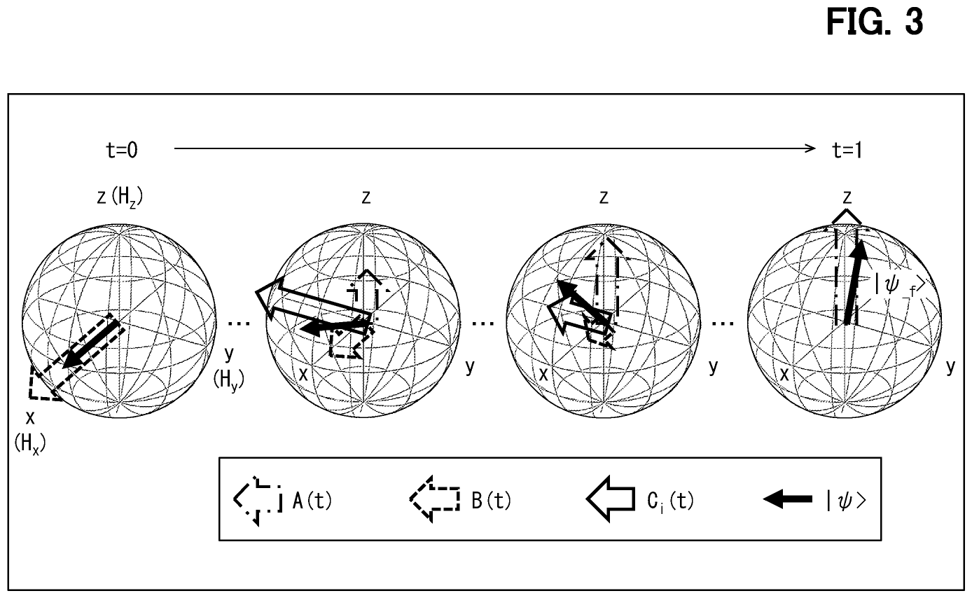

The annealing block 100 is realized by a combination of the processor 12 and the memory 10 of the quantum computer. The annealing block 100 may be realized by a combination of the processor 12 and the memory 10 of the classical computer. The annealing block 100 may be realized by combinations of the processors 12 and the memories 10 of the quantum computer and the classical computer. The annealing block 100 performs an annealing process by the annealing method. Specifically, the annealing block 100 of the present embodiment is configured to perform the annealing process such that each contribution of a cost function H_{z}, a transverse field function Hₓ, and an orthogonal field function H_{y} shown in FIG. 3 is individually controlled depending on time. Hereinafter, the annealing process by the annealing block 100 is referred to as a QA (quantum annealing) process.

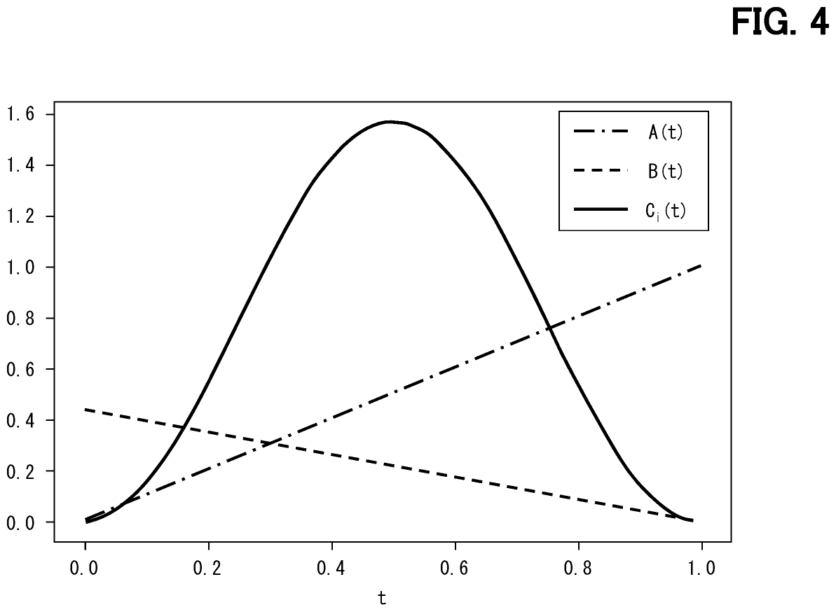

The QA process is based on an Ising model (i.e. spin glass model) in which qubits correspond to binary variables of the combinatorial optimization problem. As expressed in the formula 1, in the QA processing, the cost function H_{z}, the transverse field function Hₓ, and the orthogonal field function H_{y} are combined to be total Hamiltonian H. In the formula 1,1′ is the elapsed time in the QA process, which varies in the numerical range between 0 and _{T} in the present embodiment as shown in FIGS. 3, 4, where ‘_{T}’ is the annealing time.

[symbol]

=A(t) [symbol] _{Z}+B(t) [symbol] + [symbol] _{y} (Formula 1)

A cost function H_{z} is z-component of the total Hamiltonian H shown in FIG. 3. The cost function H_{z} expressed in the formula 2 is a function that causes the convergence by optimization in the combinatorial optimization problem. In the formula 2, ‘σᵢ^{z}’ and ‘σⱼ^{z}’ or are Pauli matrices for a pair of qubits of indexes i and j. In the formula 2, Jᵢⱼ is a coupling constant expressed in the formula 3 using a weight matrix wᵢⱼ of the combinatorial optimization problem. In particular, the coupling constant Jᵢⱼ of the present embodiment is defined as a random variable that satisfies the formulas 4, 5 such that the interaction based on SK (Sherrington-Kirkpatrick) Model is applied to the combinatorial optimization problem. ‘N’ in the formula 5 is the number of the qubits corresponding to the number of the binary variables and is the number of the spins in the cost function H_{z}. In the combinatorial optimization problem using such cost function H_{z}, the optimal solution is obtained from 2^{N} combinations.

$${z}_{} = - {\sum }_{i < j} {J}_{ij} {σ}_{i}^{z} {σ}_{j}^{z} \qquad ( Formula 2 )$$

$${J}_{ij} = - {w}_{ij} \qquad ( Formula 3 )$$

$$P ( {J}_{ij} ) \sim \frac{1}{\sqrt{2 π {s}^{2}}} exp ( - \frac{{J}_{ij}^{2}}{2 {s}^{2}} ) \qquad ( Formula 4 )$$

$${s}^{2} = \frac{1}{N - 1} \qquad ( Formula 5 )$$

Coefficient A(t) for the cost function H_{z} in the formula 1 is expressed in the formula 6 as a function of time shown in FIG. 3 for independent control of the cost function H_{z} depending on time. In the formula 6, ‘t’ is the elapsed time as in the formula 1. In the formula 6, ‘_{T}’ is the annealing time from the start to the end of the QA process, and is simplified as a value 1 in the present embodiment. In the formula 6, ‘a’ is an intensity parameter for maximizing the coefficient A(t), and is simplified as a value 1 in the present embodiment.

A(t)=at/τ (Formula 6)

The transverse field function Hₓ is x-component of the total Hamiltonian H shown in FIG. 3. The transverse field function Hₓ is expressed in the formula 7 as a formula for the quantum fluctuation representing a uniform magnetic field in the x-axis direction orthogonal to the cost function H_{z} in the z-axis direction. In the formula 7, ‘σᵢ^{x}’ is Pauli matrix for a qubit of index i.

$${x}_{} = - {\sum }_{i} {σ}_{i}^{x} \qquad ( Formula 7 )$$

Coefficient B(t) for the transverse field function Hₓ in the formula 1 is expressed in the formula 8 as a function of time shown in FIG. 3 for independent control of the transverse field function Hₓ depending on time. In the formula 8, 1′ is the elapsed time as in the formula 1. In the formula 8, ‘_{T}’ is the annealing time as in the formula 6. In the formula 8, ‘b’ is an intensity parameter for maximizing the coefficient B(t). In the present embodiment, an optimal parameter, e.g. 0.43, which is tested by experiments in advance is set for the intensity parameter b.

B(t)=b(1−t/τ) (Formula 8)

The orthogonal field function H_{y} is y-component of the total Hamiltonian H shown in FIG. 3. The orthogonal field function H_{y} is expressed in the formula 9 as a formula representing a non-uniform magnetic field in the y-axis direction orthogonal to the cost function H_{z} in the z-axis direction and the transverse field function Hₓ in the x-axis direction. In the formula 9, ‘σᵢ^{y}’ is Pauli matrix for a qubit of index i.

$${y}_{} = - {\sum }_{y} {C}_{i} ( t ) {σ}_{i}^{y} \qquad ( Formula 9 )$$

Coefficient Ci(t) for the orthogonal field function H_{y} in the formula 9 is expressed in the formula 10 as a function of time shown in FIG. 3 for independent control of the orthogonal field function H_{y} depending on time. In the formula 10, 1′ is the elapsed time as in the formula 1. In the formula 10, ‘_{T}’ is the annealing time as in the formula 6. In the formula 10, ‘cᵢ’ is an intensity parameter for maximizing the coefficient Ci(t) for the qubit of the index i. In the present embodiment, the cᵢ is set by the optimization block 110 as described later.

Cᵢ(t)=cᵢ sin²(πt/τ) (Formula 10)

Through the QA process, the final state of the wave function Ψ shown in FIG. 3 for the total Hamiltonian H is acquire based on the time-dependent control of the total Hamiltonian by the quantum annealing. The final state Ψ__{f} at the time=1 is obtained in accordance with Schrodinger equation expressed in the formula 11 under the time-dependent control of the total Hamiltonian H in the QA process.

$$\frac{d}{dt} \vert ψ 〉 = - i \vert ψ 〉 = - i ( A ( t ) {z}_{} + B ( t ) {x}_{} + {y}_{} ) \vert ψ 〉 \qquad ( Formula 11 )$$

In the time-dependent control of the QA process, the coefficient A(t), which can be called the contribution of the cost function H_{z} to the total Hamiltonian H, is gradually increased from zero to the final value as the time t passes. Particularly, in the time-dependent control of the present embodiment, the output value of the coefficient A(t) is increased, to the set final intensity parameter a which is an end value, proportionally to the elapsed time t. Further, in the time-dependent control of the QA process, the coefficient B(t), which can be called the contribution of the transverse field function Hₓ to the total Hamiltonian H, is decreased from the initial value to zero as the time t elapses. Particularly, in the time-dependent control of the present embodiment, the output value of the coefficient B(t) is decreased, from the set initial intensity parameter b which is the initial value, proportionally to the elapsed time t. Further, in the time-dependent control of the QA process, the coefficient Ci(t), which can be called the contribution of the orthogonal field function H_{y} to the total Hamiltonian H, is increased from zero to the maximum value as the time t elapses, and then is decreased to zero as the time t elapses. Particularly, in the time-dependent control of the present embodiment, the output value of the coefficient Ci(t) is varied proportionally to the square of the sine function such that the output value of the coefficient Ci(t) fluctuates at the midpoint of the elapsed time t until the intensity parameter increases to the set maximum value.

The optimization block 110 shown in FIG. 2 is realized by a combination of the processor 12 and the memory 10 of the quantum computer. The annealing block 100 may be realized by a combination of the processor 12 and the memory 10 of the classical computer. The annealing block 100 may be realized by a combinations of the processors 12 and the memories 10 of the quantum computer and the classical computer. The optimization block 110 performs an optimization process to narrow down the solution space of the combinatorial optimization problem in order to solve the combinatorial optimization problem with binary variables. Specifically, the optimization block 110 is configured to perform the optimization process by determining the optimal value of the contribution of the orthogonal field function H_{y} for each qubit of the combinatorial optimization problem based on the final state obtained in the QA process. Hereinafter, the optimization process performed by the optimization block 110 is referred to as QGO (Quantum Greedy Optimization) process.

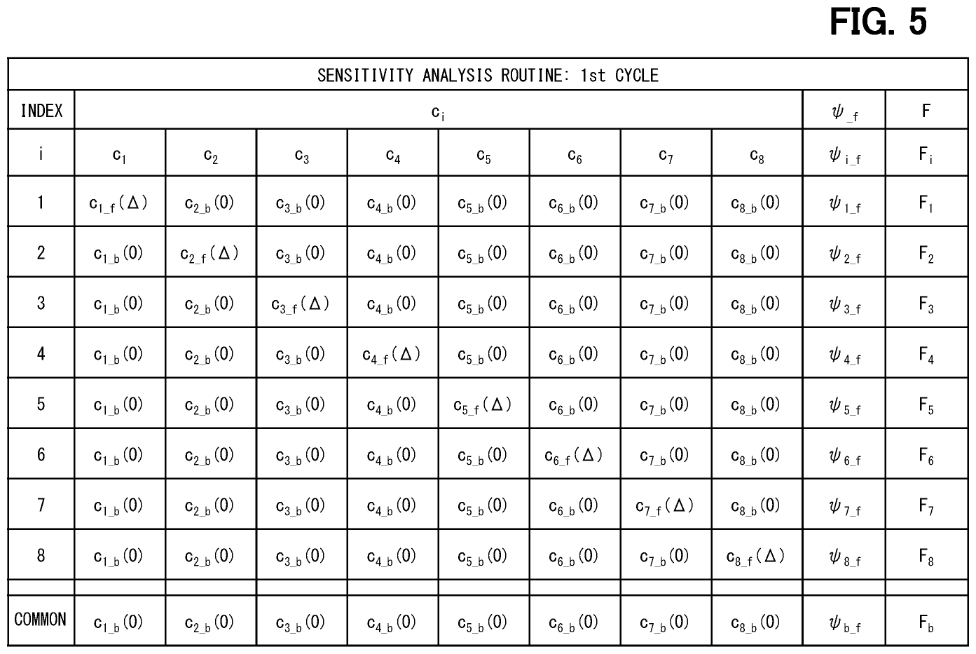

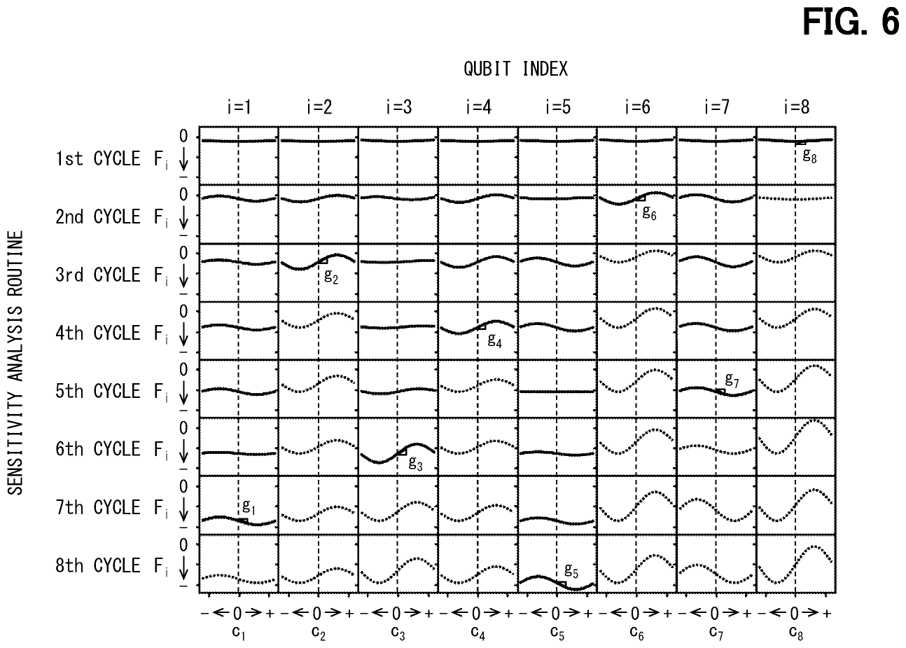

In the QGO process, the intensity parameter cᵢ for each of N qubits whose values (combination of binary values) are to be optimized, i.e. qubits of indexes i (1 to N) which have not optimized yet, is initialized to the reference intensity parameter c_{i_b} expressed in the formula 12. In the present embodiment, the reference intensity parameter c_{i_b} for the qubit of each index is zero as shown in FIG. 5. In FIGS. 5, 6-9, a case where N is 8 (that is, i is an integer value between 1 and 8) is shown as an example.

C_{i_b}=0 (Formula 12)

In the QGO process, as the intensity parameter cᵢ of each qubit of the index i in addition to the reference intensity parameter c_{i_b}, varied intensity parameter c_{i_f} is set for each qubit of the index i. The varied intensity parameter c_{i_f} is the intensity parameter cᵢ calculated by adding minute quantity Δ to the reference intensity parameter c_{i_b} as expressed in the formula 13. In the QGO process in which the reference intensity parameter c_{i_b} is initialized to zero, the varied intensity parameters c_{i_f} (=Δ) are set as shown in FIG. 5. In the present embodiment, the minute quantity Δ is set to be the optimal quantity such as 0.1, which is tested by experiment in advance.

c_{i_f}=c_{i_b}+Δ=Δ (Formula 13)

In the QGO process, the sensitivity analysis subroutine is iterated based on the reference intensity parameter c_{i_b} and the varied intensity parameter c_{i_f} which is slightly changed from the reference intensity parameter c_{i_b}. In this sensitivity analysis subroutine, the reference intensity parameter c_{i_b} and the varied intensity parameter c_{i_f} are passed from the QGO process performed by the optimization block 110 to the QA process performed by the annealing block 100 as shown in FIG. 2.

In response to the passing in the sensitivity analysis subroutine, the annealing block 100 performs the QA process by the quantum annealing for the total Hamiltonian H that includes the varied intensity parameter c_{i_f} corresponding to the index i and the reference intensity parameter c_{i_b} that does not correspond to the index i for each qubit before optimization. As a result, the analysis final state Ψ_{i_f} is obtained as the final state Ψ__{f} of the wave function for the total Hamiltonian H for each qubit before optimization. The qubit before optimization may mean the qubit for which the intensity parameter has not optimized yet. At the same time, the annealing block 100 performs the QA process by the quantum annealing for the total Hamiltonian H that includes the reference intensity parameters c_{i_b} of all indexes i, in common with all qubits before optimization as shown in FIG. 5. As a result, the reference final state Ψ_{b_f} is obtained as the final state Ψ__{f} of the wave function for the total Hamiltonian H, in common with all qubits before optimization.

In the sensitivity analysis subroutine of the QGO process, the analysis final state Ψ_{i_f} and the reference final state Ψ_{b_f} are obtained by the optimization block 110 as the measured data of the QA process from the annealing block 100, as shown in FIG. 2. The passing of the parameters c_{i_f}, c_{i_b} and the acquisition of the final states Ψ_{i_f}, Ψ_{b_f} may each be performed once, which is simultaneous to the qubits before optimization. The passing of the required parameters (see FIG. 5) and the acquisition of the final state Ψ_{i_f} may be alternately performed once for each qubit before optimization, and the passing of the parameter c_{i_b} and the acquisition of the final state Ψ_{b_f} may further be performed once. In any case, when the final state Ψ_{i_f} for each qubit before optimization and the final state Ψ_{b_f} common to those qubits are obtained as the measured data, the sensitivity analysis subroutine of the QGO process is resumed.

In the sensitivity analysis subroutine of the QGO process, the analysis evaluation indicator Fᵢ is defined as an evaluation indicator that individually evaluates the obtained analysis final state Ψ_{i_f} for each qubit before optimization as shown in FIG. 5. Particularly, the analysis evaluation indicator Fᵢ of the present embodiment is defined as an energy value of the analysis final state Ψ_{i_f} (Formula 14) in the case where the intensity parameter c is varied individually for each qubit before optimization. Further, in the sensitivity analysis subroutine, the reference evaluation indicator F_{b} is defined as an evaluation indicator F for evaluating with a common criterion for the obtained reference final state Ψ_{b_f} of each qubit before optimization as shown in FIG. 5. Particularly, the reference evaluation indicator F_{b} of the present embodiment is defined as the energy value of the reference final state Ψ_{b_f} expressed in the formula 15 according to the analysis evaluation indicator Fᵢ.

Fᵢ= [symbol] Ψ_{i_f}| [symbol] _{z}|Ψ_{i_f} [symbol] (Formula 14)

F_{b}= [symbol] Ψ_{b_f}| [symbol] _{z}|Ψ_{b_f} [symbol] (Formula 15)

In the sensitivity analysis subroutine of the QGO process, the optimization operation is performed to extract one qubit of index i, whose corresponding analysis evaluation indicator Fᵢ is optimal, from all qubits before optimization. Here, the gradient gᵢ between the analysis evaluation indicator Fᵢ and the reference evaluation indicator F_{b} according to the individual change of the intensity parameter cᵢ is expressed in the formula 16 for each qubit before optimization using the minute quantity Δ of the individual change. In the optimization operation, the qubit with the largest absolute value of the gradient gᵢ among all qubits before optimization is extracted according to the formula 17 based on the gradient gᵢ of the energy value, which is the analysis evaluation indicator Fᵢ in the present embodiment. Since the index i is used for the optimal qubit in the analysis evaluation indicator Fᵢ after the optimization operation, the indexes k, m are used for the qubits before optimization for explanation.

$${ℊ}_{i} = ( {F}_{i} - {F}_{b} ) / Δ \qquad ( Formula 16 )$$

$$i ← {arg max}_{k ∈ \{ m \vert {c}_{m} = 0 \}} \vert {ℊ}_{k} \vert \qquad ( Formula 17 )$$

In the sensitivity analysis subroutine of the QGO process, the optimal intensity parameter c_{i_o} expressed in the formula 18 is determined, as the optimal value of the intensity parameter c for the qubit whose analysis evaluation indicator Fᵢ is optimized, based on the gradient gᵢ of the analysis evaluation indicator Fᵢ of this optimized qubit as shown in FIG. 6. ‘c_{c}’ in the formula 18 is set to be the optimal parameter, e.g. π/2 (i.e. 1.57) which is tested in advance by the experiment in the present embodiment, as a constant parameter common to all N qubits.

c_{i_o}=−c_{c} sgn gᵢ (Formula 18)

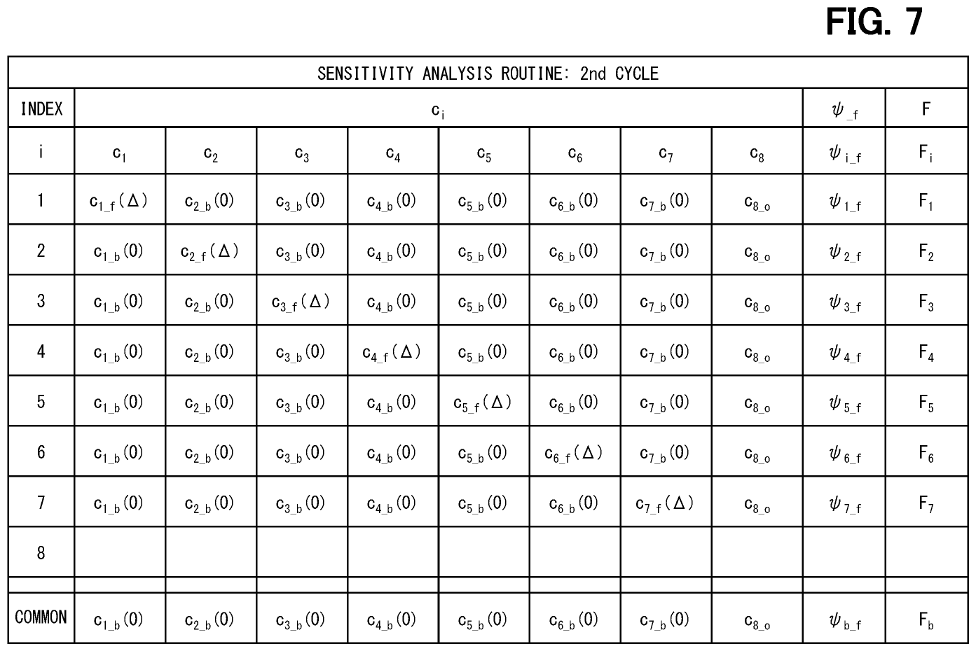

The sensitivity analysis subroutine of the QGO process is repeated each time the optimal intensity parameter c_{i_o} is determined as the optimal value, changing the target to be passed to the QA process by the annealing block 100, as shown in FIGS. 7-9. That is, in the second and subsequent cycles of the sensitivity analysis subroutine, for all optimal qubits that have already been optimized in the preceding cycles, the corresponding optimal intensity parameter c_{i_o} of index i is passed instead of the corresponding reference intensity parameter c_{i_b} of index i. In the QA process in which the analysis final state Ψ_{i_f} is obtained, the reference intensity parameters c_{i_b} that do not correspond to the index i of the qubits before optimization but correspond to the index i of the optimal intensity parameter c_{i_o} are replaced with the optimal intensity parameter c_{i_o}. At the same time, in the QA process for obtaining the reference final state Ψ_{b_f}, the reference intensity parameter c_{i_b} of the index i is replaced by the optimal intensity parameter c_{i_o} of the index i.

The passing of the parameters c_{i_f}, c_{i_b}, c_{i_o} and the acquisition of the final states Ψ_{i_f}, Ψ_{b_f} may each be performed once, which is simultaneous to the qubits before optimized. The passing of the required parameters (see FIG. 5) and the acquisition of the final state Ψ_{i_f} may be alternately performed once for each qubit before optimization, and the passing of the parameter c_{i_b} and the acquisition of the final state Ψ_{b_f} may further be performed once. In any case, when the final states Ψ_{i_f} for all qubits before optimization and the final state Ψ_{b_f} common to those qubits are obtained as the measured data, the second and subsequent cycle of the sensitivity analysis subroutine of the QGO process is resumed.

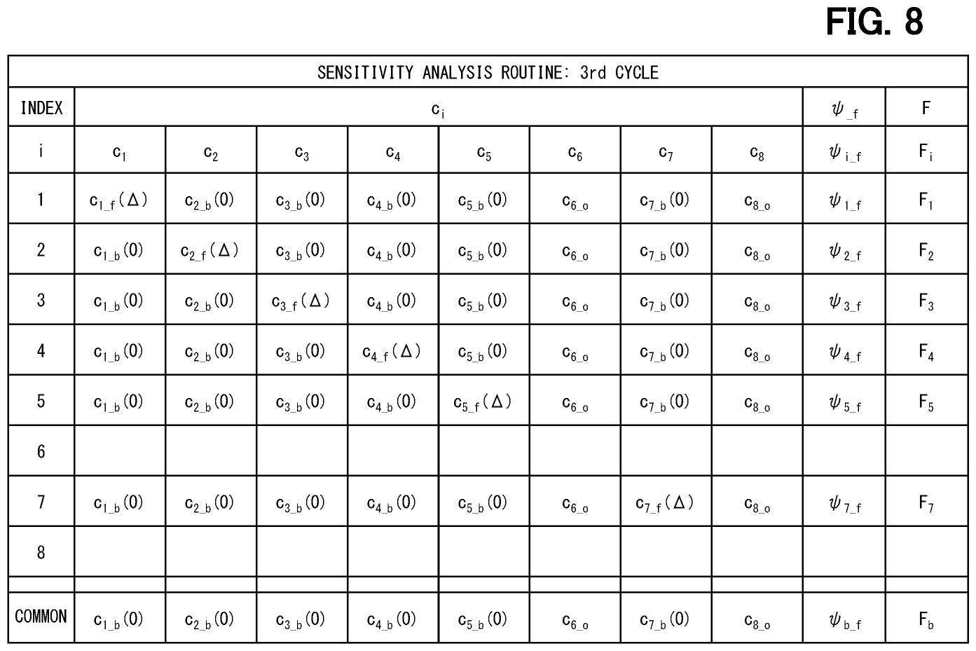

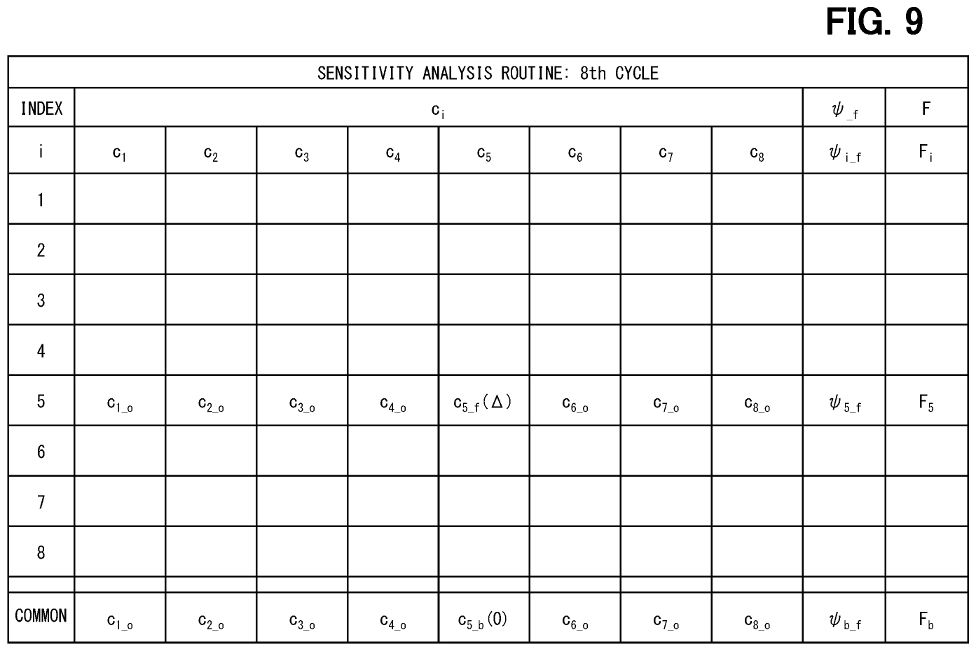

In the second and subsequent cycles of the sensitivity analysis subroutine that acquired the measured data from such QA process, the optimal intensity parameter c_{i_o} for the qubit whose analysis evaluation indicator Fᵢ is optimized in the current cycle is determined based on the gradient gᵢ. In FIG. 7, as an example of the second cycle of the sensitivity analysis subroutine shown in FIG. 6, the QGO process is illustrated, where the qubit of the index i=8 was optimized in the first cycle of the sensitivity analysis subroutine shown in FIG. 6. In FIG. 8, as an example of the third cycle of the sensitivity analysis subroutine shown in FIG. 6, the QGO process is illustrated, where the qubits of indexes 8 and 6 were optimized in the first and second cycles of the sensitivity analysis subroutine shown in FIG. 6. In FIG. 9, as an example of the eighth cycle of the sensitivity analysis subroutine shown in FIG. 6, the QGO process is illustrated, where all qubits except for the qubit of the index 5 were optimized in the first to seventh cycles of the sensitivity analysis subroutine shown in FIG. 6.

In the QGO process, the optimal intensity parameters c_{i_o} for all N qubits are determined by iterating the sensitivity analysis subroutine for N times as shown in FIG. 6. After the optimal intensity parameters c_{i_o} for all qubits are determined in the QGO process, the optimal solution OA of the combinatorial optimization problem is output by mapping the set of the optimal intensity parameters c_{i_o} to the solution of the combinatorial optimization problem using the formula 19. In the QGO process, the output optimal solution OA is stored in the memory 10. Here, the optimal solution OA may be stored to be retained after the processing system 1 is turned off. Alternatively, the stored optimal solution OA may be deleted when the processing system 1 is turned off.

OA=(sgnc₁_{ₒ},sgnc₂_{ₒ},sgnc_{N}_{ₒ}) (Formula 19)

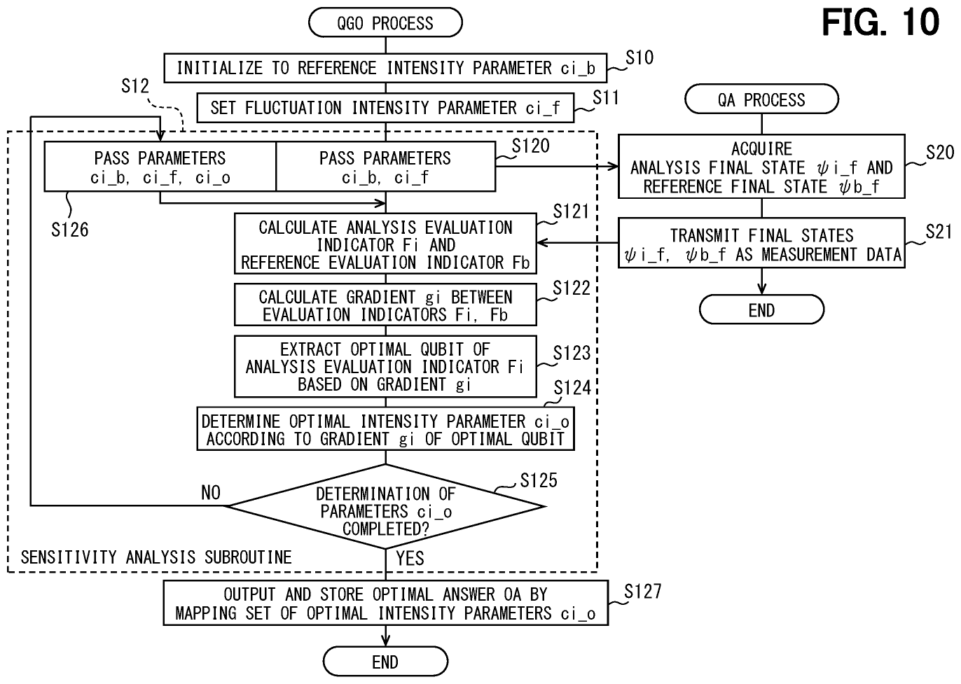

With the cooperation of the blocks 100, 110 described above, the processing method in which the processing system 1 controls the quantum annealer with qubits to solve the combinatorial optimization problem with binary variables is performed according to the sequence diagram shown in FIG. 10. The processing method shown in the sequence diagram is performed in response to the instruction from the operator of the processing system 1, for example. “S” in the sequence diagram means steps executed by instructions included in at least one processing program.

In S10 of the QGO process, the optimization block 110 initializes the intensity parameters c for all qubits before optimization to the reference intensity parameter c_{i_b}. In S11 of the QGO process, the optimization block 110 sets the varied intensity parameter c_{i_f} for each qubit. The varied intensity parameter c_{i_f} is varied from the reference intensity parameter c_{i_b}. In S12 of the QGO process, the optimization block 110 repeatedly performs the sensitivity analysis subroutine which includes S120-S127.

Specifically, in S120 of the sensitivity analysis subroutine, the optimization block 110 passes the reference intensity parameter c_{i_b} and the varied intensity parameter c_{i_f} to the annealing block 100. After the intensity parameters c_{i_b}, c_{i_f} are passed, the sensitivity analysis subroutine is held back until all measured data is received from the annealing block 100.

In S20 of the QA process started in response to the passing of all measured data, the annealing block 100 acquires the analysis final state Ψ_{i_f}, which is independent for each qubit before optimization, by the quantum annealing. Further in S20, the annealing block 100 acquires the reference final state Ψ_{b_f}, which is common to the qubits before optimization, by the quantum annealing different from the quantum annealing for the analysis final state Ψ_{i_f}. In S21 of the QA process, the annealing block 100 transmits the analysis final state Ψ_{i_f} and the reference final state Ψ_{b_f} to the optimization block 110 as the measured data.

The passing of the parameters c_{i_f}, c_{i_b} in S120 and the acquisition of the final states Ψ_{i_f}, Ψ_{b_f} in S20, S21 may each be performed once, which is simultaneous to the qubits before optimization. The passing of the required parameters in S120 and the acquisition and the transmission of the final state Ψ_{i_f} in S20, 21 may be alternately performed once for each qubit before optimization, and the passing of the parameter c_{i_b} in S120 and the acquisition and the transmission of the final state Ψ_{b_f} in S20, S21 may further be performed once.

In S121 of the sensitivity analysis subroutine resumed in response to the reception of the measured data, the optimization block 110 calculates the analysis evaluation indicator Fᵢ for each qubit before the optimization. In S121, the optimization block 110 calculates the reference evaluation indicator F_{b} that is common to each qubit before optimization.

In S122 of the sensitivity analysis subroutine, the optimization block 110 calculates the gradient gᵢ between the analysis evaluation indicator Fᵢ and the reference evaluation indicator F_{b} for each qubit before optimization. In S123 of the sensitivity analysis subroutine, the optimization block 110 extracts, as the optimal qubit based on the gradient gᵢ, one qubit whose analysis evaluation indicator Fᵢ is optimized from the qubits before optimization.

In S124 of the sensitivity analysis subroutine, the optimization block 110 determines, as the optimal value of the intensity parameter cᵢ for the optimal qubit, the optimal intensity parameter c_{i_o} according to the gradient gᵢ of the analysis evaluation indicator Fᵢ for the optimal qubit. In S125 of the sensitivity analysis subroutine, the optimization block 110 determines whether the determination of the optimal intensity parameter c_{i_o} has been completed for all N qubits.

When a negative determination is made in S125, S126 is performed instead of S120 to repeat the sensitivity analysis subroutine. In S126, the optimization block 110 passes, to the annealing block 100, the determined optimal intensity parameter c_{i_o} instead of the reference intensity parameter c_{i_b} of the same index i, and the reference intensity parameter c_{i_b} and the varied intensity parameter c_{i_f} of the other indexes as in S120. After the intensity parameters c_{i_b}, c_{i_f}, c_{i_o} are passed, the sensitivity analysis subroutine is held back until all measured data is received as a result of S20, S21 from the annealing block 100, as in the step following S120.

The passing of the parameters c_{i_f}, c_{i_b}, c_{i_o} in S126 and the acquisition of the final states Ψ_{b_f} in S20, S21 may each be performed once, which is simultaneous to the qubits which have not been optimized. The passing of the required parameters in S120 and the acquisition and the transmission of the final state Ψ_{i_f} in S20, 21 may be alternately performed once for each qubit before optimization, and the passing of the parameter c_{i_b} in S120 and the acquisition and the transmission of the final state Ψ_{b_f} in S20, S21 may further be performed once.

In contrast, when a positive determination is made in S125, the sensitivity analysis subroutine ends and the process proceeds to S127. In S127 of the QGO process, the optimization block 110 outputs the optimal solution OA of the combinatorial optimization problem by mapping the set of the optimal intensity parameters c_{i_o} determined for all N qubits. Further in S127, the optimization block 100 stores the output optimal solution OA to the memory 10. Thus, one cycle of the process shown in the sequence diagram ends.

### Operation Effects

In the QGO process of the present embodiment, the optimal values of the contribution of the orthogonal field function H_{y} are sequentially determined for each qubit based on the final state Ψ__{f} of the QA process for independently controlling the contributions of the cost function H_{z}, the transverse field function Hₓ, and the orthogonal field function H_{y} depending on time. According to the QGO process of the present embodiment, the qubit that gives the optimal evaluation indicator F for the final state Ψ__{f} of the QA process in which the intensity parameter c for maximizing the orthogonal field function H_{y} is varied is extracted based on the gradient gᵢ.

According to this, even if the annealing time in the QA process is shortened, the solution space of the combinatorial optimization problem can be narrowed down by sequentially determining the intensity parameter cᵢ, which is the optimal value for extracted qubit, based on the gradient gᵢ. Accordingly, accurate optimal solution OA can be output by mapping the set of the intensity parameters c determined for all qubits. Therefore, accurate optimal solution OA can be obtained with shorter annealing time. Accurate optimal solution OA (i.e. optimal solution OA with high accuracy) may mean the optimal solution with large probability amplitude, or the solution with the cost function H_{z} having lower value.

### OTHER EMBODIMENTS

Although one embodiment has been described, the present disclosure should not be limited to the above embodiment and may be applied to various other embodiments within the scope of the present disclosure.

In the optimization block 110 that performs S121 of a modification example, the analysis evaluation indicator Fᵢ and the reference evaluation indicator F_{b} may be defined as the error expressed in the formulas 20, 21 using the probability to find the ground state Ψ__{gs} of the wave function Ψ, i.e. fidelity. In the optimization block 110 that performs S123, S124 of a modification example, two or more qubits whose analysis evaluation indicators Fᵢ are optimal may be extracted in one cycle of the sensitivity analysis subroutine. In this case, the optimal intensity parameter c_{i_o} may be determined for each optimal qubit. In the annealing block 100 that performs S20 of a modification example, the time-dependent control may be realized by transforming, by time-dependent unitary transformations, Pauli matrix σᵢ^{y} expressed in the formula 9 into the time-dependent Pauli matrix σᵢ^{x} and Pauli matrix σᵢ^{z} to make new total Hamiltonian H.

Fᵢ=1− [symbol] Ψ_{i_f}|Ψ__{gs} [symbol] ² (Formula 20)

F_{b}=1− [symbol] Ψ_{b_f}|Ψ__{gs} [symbol] ² (Formula 21)

The above-described embodiment and the modification example may be realized as a computer device or a semiconductor device (e.g. semiconductor chip) that has at least one processor 12 and at least one memory 10 of the processing system 1. The QGO process of the above-described embodiment and the modification example may be performed by executing computer program other than the program for the QA process by a computer device or a semiconductor device other than the device for the QA process. In this case, the computer device or the semiconductor device that performs only the QGO process may include at least one of the quantum computer and the classical computer as the dedicated computer. The computer device or the semiconductor device that performs only the QGO process may include only the classical computer as the dedicated computer.

What is claimed is:

1. A processing system configured to solve a combinatorial optimization problem with binary variables by controlling a quantum annealer with qubits, the processing system comprising a processor configured to:
perform an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and
perform an optimization process to sequentially determine an optimal value of the contribution of the orthogonal field function for each of the qubits corresponding to one of the binary variables of the combinatorial optimization problem based on a final state of the annealing process, wherein
the processor is configured to, in the optimization process,
extract, from the qubits that have not been optimized, the qubit that optimizes an evaluation indicator for the final state of the annealing process in which an intensity parameter that gives a maximum value of the orthogonal field function is varied, based on a gradient caused by the variation,
determine the intensity parameter that gives the optimal value for the extracted qubit based on the gradient, and
output an optimal solution of the combinatorial optimization problem by mapping a set of the intensity parameters determined for each of the qubits.

2. The processing system according to claim 1, wherein
the processor is configured to, in the optimization process, extract the qubit that optimizes an energy value of the final state which is the evaluation indicator.

3. The processing system according to claim 1, wherein
the processor is configured to, in the optimization process, extract the qubit that optimizes the evaluation indicator when the intensity parameters initialized to zero for the qubits that have not been optimized are varied.

4. The processing system according to claim 1, further comprising:
a storage medium, wherein
the processor is configured to, in the optimization process, store the optimal solution to the storage medium.

5. The processing system according to claim 1, wherein
the processor is configured to, in the annealing process, acquire the final state of a wave function for a total Hamiltonian including the cost function, the transverse field function, and the orthogonal field function based on time-dependent control of the total Hamiltonian by the quantum annealing.

6. The processing system according to claim 5, wherein
the processor is configured to, in the annealing process,
increase the contribution of the cost function from zero to an end value as time elapses,
decrease the contribution of the transverse field function from a start value to zero as time elapses, and
increase the contribution of the orthogonal field function from zero to the maximum value, and then decrease the contribution of the orthogonal field function from the maximum value to zero as time elapses.

7. A processing device configured to solve a combinatorial optimization problem with binary variables by controlling a quantum annealer with qubits, the processing device comprising a processor configured to:
perform an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and
perform an optimization process to sequentially determine an optimal value of the contribution of the orthogonal field function for each of the qubits corresponding to one of the binary variables of the combinatorial optimization problem based on a final state of the annealing process, wherein
the processor is configured to, in the optimization process,
extract, from the qubits that have not been optimized, the qubit that optimizes an evaluation indicator for the final state of the annealing process in which an intensity parameter that gives a maximum value of the orthogonal field function is varied, based on a gradient caused by the variation,
determine the intensity parameter that gives the optimal value for the extracted qubit based on the gradient, and
output an optimal solution of the combinatorial optimization problem by mapping a set of the intensity parameters determined for each of the qubits.

8. A processing device configured to solve a combinatorial optimization problem with binary variables by controlling a quantum annealer with qubits, the processing device comprising:
a processor, wherein
an annealing process is defined as a process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function,
an optimization process is defined as a process to sequentially determine an optimal value of the contribution of the orthogonal field function for each of the qubits corresponding to one of the binary variables of the combinatorial optimization problem based on a final state of the annealing process,
the processor is configured to, as the optimization process,
extract, from the qubits that have not been optimized, the qubit that optimizes an evaluation indicator for the final state of the annealing process in which an intensity parameter that gives a maximum value of the orthogonal field function is varied, based on a gradient caused by the variation,
determine the intensity parameter that gives the optimal value for the extracted qubit based on the gradient, and
output an optimal solution of the combinatorial optimization problem by mapping a set of the intensity parameters determined for each of the qubits.

9. A processing method to solve a combinatorial optimization problem with binary variables by controlling a quantum annealer with qubits, the processing method comprising:
performing an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and
performing an optimization process to sequentially determine an optimal value of the contribution of the orthogonal field function for each of the qubits corresponding to one of the binary variables of the combinatorial optimization problem based on a final state of the annealing process, wherein
the optimization process includes
extracting, from the qubits that have not been optimized, the qubit that optimizes an evaluation indicator for the final state of the annealing process in which an intensity parameter that gives a maximum value of the orthogonal field function is varied, based on a gradient caused by the variation,
determining the intensity parameter that gives the optimal value for the extracted qubit based on the gradient, and
outputting an optimal solution of the combinatorial optimization problem by mapping a set of the intensity parameters determined for each of the qubits.

10. A processing method to solve a combinatorial optimization problem with binary variables by controlling a quantum annealer with qubits, wherein
an annealing process is defined as a process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function, and
an optimization process is defined as a process to sequentially determine an optimal value of the contribution of the orthogonal field function for each of the qubits corresponding to one of the binary variables of the combinatorial optimization problem based on a final state of the annealing process,
the processing method comprises, as the optimization process:
extracting, from the qubits that have not been optimized, the qubit that optimizes an evaluation indicator for the final state of the annealing process in which an intensity parameter that gives a maximum value of the orthogonal field function is varied, based on a gradient caused by the variation;
determining the intensity parameter that gives the optimal value for the extracted qubit based on the gradient; and
outputting an optimal solution of the combinatorial optimization problem by mapping a set of the intensity parameters determined for each of the qubits.

11. A computer program product stored on at least one non-transitory computer readable medium to solve a combinatorial optimization problem with binary variables by controlling a quantum annealer with qubits, the computer program product comprising instructions configured to, when executed by at least one processor, cause the at least one processor to:
perform an annealing process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function; and
perform an optimization process to sequentially determine an optimal value of the contribution of the orthogonal field function for each of the qubits corresponding to one of the binary variables of the combinatorial optimization problem based on a final state of the annealing process, wherein
the instructions are configured to, when executed by the at least one processor, cause the at least one processor to, in the optimization process,
extract, from the qubits that have not been optimized, the qubit that optimizes an evaluation indicator for the final state of the annealing process in which an intensity parameter that gives a maximum value of the orthogonal field function is varied, based on a gradient caused by the variation,
determine the intensity parameter that gives the optimal value for the extracted qubit based on the gradient, and
output an optimal solution of the combinatorial optimization problem by mapping a set of the intensity parameters determined for each of the qubits.

12. A computer program product stored on at least one non-transitory computer readable medium to solve a combinatorial optimization problem with binary variables by controlling a quantum annealer with qubits, wherein
an annealing process is defined as a process to individually control, depending on time, each contribution of (i) a cost function that is to be optimized in the combinatorial optimization problem, (ii) a transverse field function that define a magnetic field orthogonal to the cost function, and (iii) an orthogonal field function that defines a magnetic field orthogonal to the cost function and the transverse field function, and
an optimization process is defined as a process to sequentially determine an optimal value of the contribution of the orthogonal field function for each of the qubits corresponding to one of the binary variables of the combinatorial optimization problem based on a final state of the annealing process,
the computer program product comprises instructions configured to, when executed by at least one processor, cause the at least one processor to, as the optimization process:
extract, from the qubits that have not been optimized, the qubit that optimizes an evaluation indicator for the final state of the annealing process in which an intensity parameter that gives a maximum value of the orthogonal field function is varied, based on a gradient caused by the variation;
determine the intensity parameter that gives the optimal value for the extracted qubit based on the gradient; and
output an optimal solution of the combinatorial optimization problem by mapping a set of the intensity parameters determined for each of the qubits.
